(19) United States
(12) Patent Application Publication
(10) Pub. No.: US 2014/0208737 A1
(43) Pub. Date: Jul. 31, 2014

(54) MECHANICAL-HYDRAULIC BRAKE BOOSTER HAVING AN EXPANSION FOR AUTONOMOUS BRAKING

(71) Applicants: Urs BAUER, Sachsenheim (DE); Matthias KISTNER, Bretzfeld (DE)

(72) Inventors: Urs BAUER, Sachsenheim (DE); Matthias KISTNER, Bretzfeld (DE)

(73) Assignee: ROBERT BOSCH GMBH, Stuttgart (DE)

(21) Appl. No.: 14/168,726

(22) Filed: Jan. 30, 2014

(30) Foreign Application Priority Data
Jan. 31, 2013 (DE) 10 2013 201 574.7

(51) Int. Cl. B60T 13/68

(52) U.S. Cl. CPC B60T 13/686
USPC 60/545

(57) ABSTRACT

A brake booster for a vehicle, including: a cylinder housing having a center bore for receiving a user-operated push-rod piston for building up a fluid pressure inside of the cylinder housing in response to actuation of the push-rod piston, a first fluid line being in fluid communication with an axial recess in the cylinder housing, and a second fluid line being in fluid communication with the center bore in a cylinder housing region, the first and second fluid lines each being connected to a fluid reservoir at their respective other ends; a third fluid line, which interconnects the first and second fluid lines in a fluid manner; a first electrically and/or hydraulically and/or mechanically operable valve, which is situated in the third fluid line; a second electrically and/or hydraulically and/or mechanically operable valve, which is situated in the second fluid line, namely, in back of a fluid connection of the third fluid line to the second fluid line, when viewed in the direction of the fluid reservoir; and a build-up of fluid pressure being able to be generated autonomously with the aid of the first valve, when the second valve interrupts a fluid stream in the second fluid line.

### FIELD OF THE INVENTION

The present invention relates to a mechanical-hydraulic brake booster having an expansion for autonomous braking, in particular, for vehicles and motor vehicles.

### BACKGROUND INFORMATION

A hydraulic brake booster having a mechanical valve for use in a vehicle is known from United States Published Patent Appln. No. 2012/0074769, which describes so-called slide valves, with the aid of which a pressure-tightness of a fluid with respect to a brake fluid reservoir of the vehicle may only be achieved in a relatively complicated manner. In addition, the brake booster described in it does not allow a so-called autonomous fluid pressure to be built up in the brake system of the vehicle or in a booster chamber of the brake booster independently of the manipulation of the brake booster by a user, i.e., the driver, that is, without active participation of the driver.

### SUMMARY

From one aspect, the present invention provides a brake booster for a vehicle, including: a cylinder housing having a center bore to receive a user-operated push-rod piston for building up a fluid pressure inside the cylinder housing in response to actuation of the push-rod piston; a first fluid line being in fluid communication with an axial recess in the cylinder housing; and a second fluid line being in fluid communication with the center bore in a cylinder housing region, the first and second fluid lines each being connected to a fluid reservoir at their respective other ends; a third fluid line, which interconnects the first and second fluid lines in a fluid manner; a first electrically and/or hydraulically and/or mechanically operable valve, which is situated in the third fluid line; a second electrically and/or hydraulically and/or mechanically operable valve, which is situated in the second fluid line, namely, in back of a fluid connection of the third fluid line to the second fluid line, when viewed in the direction of the fluid reservoir; and a build-up of fluid pressure being able to be generated autonomously with the aid of the first valve, when the second valve interrupts a fluid stream in the second fluid line.

From a second aspect, the present invention provides a vehicle, in particular, a motor vehicle, having such a brake booster.

The advantage of the proposed method is that without active participation of the user or driver, it is possible to build up the pressure of the fluid (that is, brake fluid) via a pressure source, which means that a so-called fallback level is present in the event of a breakdown or malfunction of the vehicle's on-board voltage supply, which supplies controllable regulating valves of the brake system with energy as needed, and namely, in combination with an accumulator, for example. The combination of controllable assistance and autonomous fluid pressure build-up allows functions, such as force blending, ACC (adaptive cruise control), etc. to be implemented. In addition, use of the hydromechanical brake booster in combination with only an ABS unit allows a use as a full-fledged ESP system. Furthermore, redundancy of the source of pressure build-up is conceivable, when an ABS pump is connected to the accumulator via a check valve. In this manner, when the accumulator is sized to be sufficiently large, a pump otherwise assigned to the brake booster may be omitted, which results in reductions in installation space and cost.

In the region of the axial recess, the piston push rod preferably has a radial, conical expansion, which is fixed in position on the piston push rod and corresponds, namely, to a shape of the axial recess; the piston push rod being pre-stressed by a first spring element, which is situated inside the axial recess and is supported, on one side, at an inner wall of the axial recess, about the through hole, and supported, on the other side, at a plane surface of the first conical expansion, opposite to the conical surface, so that in the non-actuated state of the piston push rod, the conical surface of the first conical expansion, together with the correspondingly formed recess, forms a seal for the fluid contained in the cylinder housing.

In addition, it is preferred that, in an actuated state of the piston push rod effected by the user, that is, when the piston push rod is displaced in such a manner, that the first conical expansion separates from the corresponding surface of the axial recess in opposition to the prestress force of the first spring element, a second radial expansion, which is fixed in position on the piston push rod, provided with a conical surface, and set apart from the first expansion, abut on a correspondingly formed surface in the cylinder housing in a sealing manner; in this manner, the second fluid line being closed, and the fluid pressure being increased by the displacement of the first expansion inside of the axial recess.

A further fluid line inside of the cylinder housing, which branches off from the first fluid line, preferably empties into the conical surface, so that when the push-rod piston is actuated, a pressure equilibrium between the region in front of and in back of the conical expansion may be produced. This assists the driver when the brake pedal or the push-rod piston is manipulated. A second spring element is advantageously positioned between the second expansion and a stop element fixed in position on the piston push rod, set apart from the second expansion; the second spring element being supported, on one side, at the stop element, and on the other side, at a plane surface of the second conical expansion, opposite to the conical surface, in order that in response to displacement, that is, actuation of the piston push rod, a relatively effective seal is produced in this manner, between the conical surface of the second expansion and the corresponding surface in the cylinder housing, due to the prestress force of the second spring element, and in order that the user is provided an option of selectively apportioning a measure of sealing or pressure build-up in the axial recess.

In addition, it is preferable for radial seals to each be fixed in position on the piston push rod in place of the first and second conical expansions; at least two radial seals being set apart from one another in such a manner, that in the non-actuated state of the piston push rod, the second fluid line is in fluid communication with the center bore of the cylinder housing, and in the non-actuated state of the piston push rod, a further radial seal seals the axial recess and the center bore from one another.

In an actuated state of the piston push rod effected by the user, that is, a displacement of the piston push rod in the direction of the axial recess, on one hand, the seal between the axial recess and the center bore for building up fluid pressure is advantageously broken, and the two radial seals set apart from one another are displaced by the piston push rod in such a manner, that the fluid connection of the second fluid line to the center bore is interrupted.

The second spring element is preferably supported, on one side, at the stop element, and on the other side, at the cylinder housing, in order to provide the user an option to selectively apportion a measure of sealing or pressure build-up in the axial recess.

Furthermore, it is preferable for the build-up of fluid pressure via the first valve to be able to be generated by the fluid reservoir, which includes an accumulator and/or an ABS pump in conjunction with a check valve. Therefore, a source of pressure build-up may be omitted in a cost-saving and space-saving manner.

In addition, it is preferred that a fluid line be situated in the cylinder housing; on one end, the fluid line emptying out into the center bore, and on the other end, the fluid line opening out to the exterior of the cylinder housing, in order to generate pressure equalization for the pressurized fluid in the center bore and therefore provide assistance during brake application.

### BRIEF DESCRIPTION OF THE DRAWINGS

FIG. 1 shows a schematic cross-sectional view of a specific embodiment of the present invention in a non-actuated state.

FIG. 2 shows a schematic cross-sectional view of a specific embodiment of the present invention in an actuated state.

FIG. 3 shows a schematic cross-sectional view of a further specific embodiment of the present invention in an actuated state.

FIG. 4 shows a schematic cross-sectional view of a further specific embodiment of the present invention in a non-actuated state.

### DETAILED DESCRIPTION

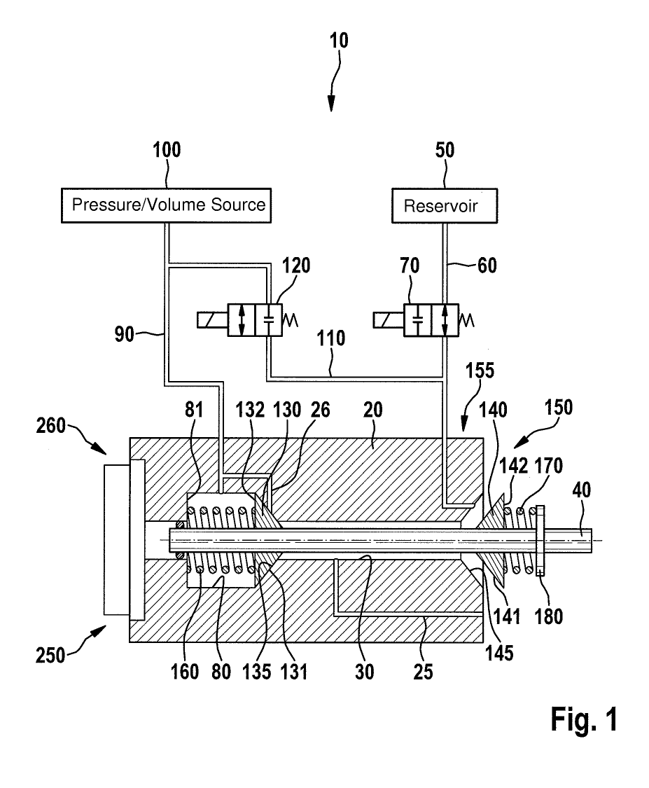

FIG. 1 shows a schematic cross-sectional view of a cylinder housing 20 of a brake booster 10, including essential components, which are explained below in detail, namely, in accordance with a specific embodiment of the present invention. In this context, it is noted that for the sake of more clarity and simpler understanding of the present invention, other components belonging to a complete brake system of a vehicle or motor vehicle have been omitted.

The brake booster includes the cylinder housing 20 having a center bore 30, through which a push-rod piston 40 protrudes. The inner diameter of center bore 30 and the outer diameter of push-rod piston 40 are dimensioned, such that piston 40 is indeed guided through bore 30, but has a certain amount of lateral play, so that (brake) fluid may flow along between piston 40 and bore 30, as is known in the related art.

A supply of fluid is situated in a reservoir 50, which is in fluid communication with center bore 30 via a fluid line (second fluid line) 60. A first valve 120, whose function is explained further below, is situated in fluid line 60.

According to the specific embodiment shown in FIG. 1, inside cylinder housing 20, center bore 30 expands in a section of it to form an axial recess 80 and is in fluid communication with a pressure/volume source 100 via a (first) fluid line 90, the pressure/volume source being explained further below.

First fluid line 90 and second fluid line 60 are in fluid communication with each other via a third fluid line 110; a second valve 70, whose function is explained further below, being situated in third fluid line 110.

In FIG. 1, two conical expansions 130, 140 are fixed in position on push-rod piston 40; conical expansion 130 being situated in axial recess 80, and conical expansion 140 being situated outside of cylinder housing 20. In terms of shape, conical expansions 130, 140, that is, their conical surfaces 131, 141, are configured to correspond to a surface 135 in axial recess 80 and a surface 145 at an end face 150 of cylinder housing 20, respectively.

A first spring element 160 situated in axial recess 80 exerts an initial stress on conical expansion 130, and consequently, on push-rod piston 40, in that spring element 160 is supported, first of all, at a surface 81 of the axial recess, and secondly, at a plane surface 132 of conical expansion 130.

In the same way, a second spring element 170 exerts an initial stress between conical expansion 140, that is, a plane surface 142, and a stop element 180, which is also fixed in position on push-rod piston 40.

FIG. 1 shows brake booster 10 in a non-actuated state, that is, the driver does not manipulate a brake pedal (not shown here) coupled to push-rod piston 40. In other words, conical expansion 130 or conical surface 131 abuts on surface 135 in a sealing manner, and conical surface 141 of conical expansion 140 does not rest against surface 145, which means that fluid line 60 is in fluid communication with center bore 30.

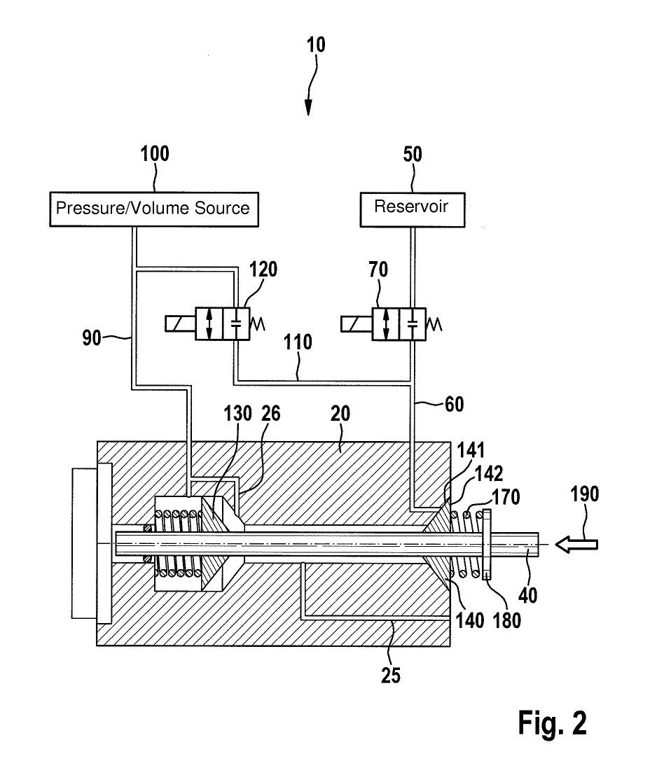

If, as indicated in FIG. 2, force (indicated by an arrow 190 in FIG. 2) is now exerted on push-rod piston 40, fluid line 60 is closed by conical surface 141, and in the drawing in FIG. 2, conical expansion 130 is displaced to the left by push-rod piston 40 and therefore compresses fluid present in axial recess 80, i.e., a pressure is exerted on the fluid; a pressure equilibrium between the fluid situated in front of and in back of conical expansion 130 being able to be generated via a fluid line 26, the pressure equilibrium being used for assisting the driver during a braking action, when the brake booster operates autonomously, as explained further below.

Referring again to FIG. 1, the functioning of specific valves 70, 120 shall now be explained, when a failure or a malfunction of the voltage supply situated aboard the vehicle occurs. In this context, valve 70 is closed (for this, see the different symbolic representations of valve 70 in FIGS. 1 and 2), which means that the fluid supply from reservoir 50 is interrupted. At the same time, the fluid pressure in pressure/volume source 100 may be increased via valve 120, without the driver having to manipulate the brake pedal coupled to push-rod piston 40 (but not shown here). Therefore, brake booster 10 may build up a fluid pressure autonomously, that is, without active assistance of the driver; if necessary, the fluid pressure being able to be “retrieved” relatively rapidly for decelerating the vehicle, which is advantageous, for example, in conjunction with an adaptive cruise control (ACC), since the driver does not have to manipulate the brake pedal unnecessarily, which would instantaneously stop the action of the ACC.

A suitably dimensioned accumulator, or an ABS pump in combination with a return valve, the latter of which is already present in most vehicles, would be conceivable as pressure-supplying sources, which would eliminate the need for a dedicated pump for brake booster 10 and consequently reduce costs and save installation space. Therefore, use of the brake booster in combination with an ABS unit as an ESP system is also conceivable.

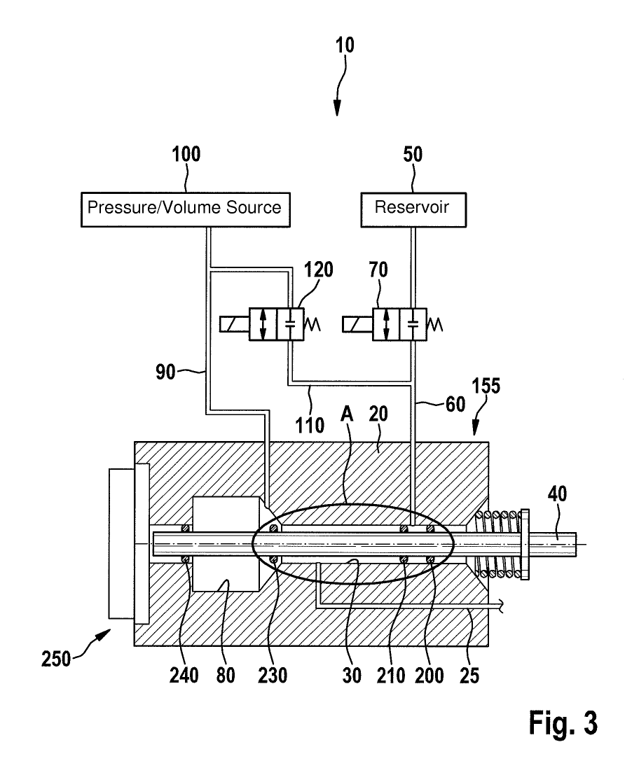

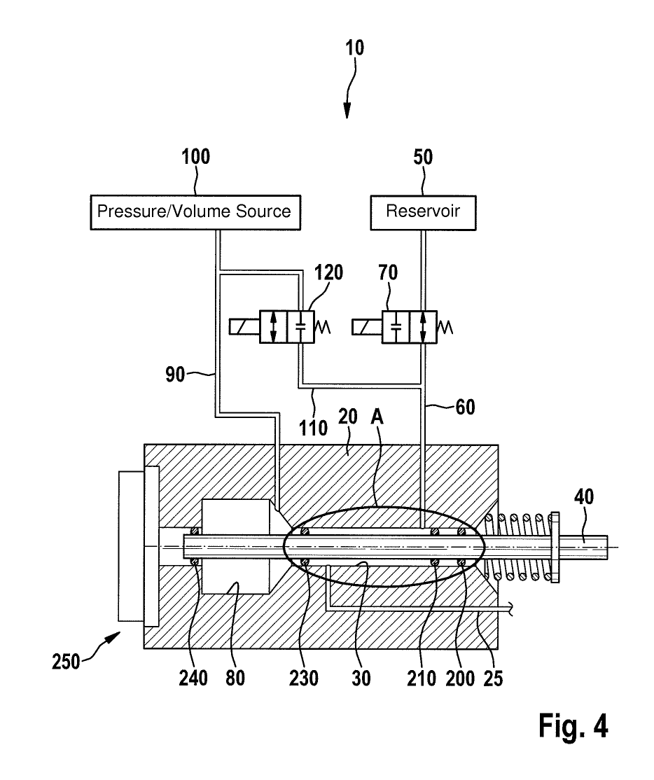

FIGS. 3 and 4 show a further specific embodiment of the present invention, where like reference symbols refer to the same elements, FIG. 3 shows an actuated state, and FIG. 4 shows a non-actuated state.

In contrast to the specific embodiment shown in FIGS. 1 and 2, the function of the conical expansions is assumed by radial seals 200, 210 and 230 fixed in position on push-rod piston 40 (each highlighted, in FIGS. 3 and 4, by an ellipse denoted by the letter “A” for better understanding).

In this context, FIG. 3 shows an actuated state of brake booster 10, i.e., radial seals 200, 210 are each situated next to the fluid inlet of fluid line 60, which means that a fluid connection between through-hole 30 and reservoir 50 is interrupted. At the same time, in FIG. 3 in the drawing, radial seal 230 is displaced to the left and therefore increases the fluid pressure in axial recess 80, the fluid pressure being transmitted by fluid line 90 to the brake system.

FIG. 4 shows a non-actuated state of brake booster 10, i.e., radial seals 200, 210 are situated next to the inlet of fluid line 60, so that reservoir 50 is in fluid communication with through-hole 30. At the same time, radial seal 230 seals axial recess 80 from the rest of through-hole 30; no force is built up in axial recess 80 by the driver. The functioning of valves 70, 120 is analogous to the above description with reference to FIGS. 1 and 2.

In each of FIGS. 1 through 4, a fluid line 25 is discernible, which, on one end, opens out into center bore 30 and, on the other end, opens out to the exterior of cylinder housing 20. Consequently, pressure equalization between the fluid situated between center bore 30 and push-rod piston 40 and the external space of cylinder housing 20 may be achieved.

Finally, with reference to FIG. 3, it is noted that push-rod piston 40 is sealed at end 250 of cylinder housing 20 by a radial seal 240, which analogously applies to the remaining figures, as well.

In addition, with reference to FIG. 1, a so-called reaction disk, to which a master brake cylinder not shown here is coupled, as known by one skilled in the art, is denoted by reference numeral 260.

At this point, it is noted that the dimensions represented in FIGS. 1 through 4 are not true to scale.

What is claimed is:

1. A brake booster for a vehicle, comprising:
a cylinder housing including a center bore for receiving a user-operated push-rod piston for building up a fluid pressure inside the cylinder housing in response to actuation of the push-rod piston;
a first fluid line in fluid communication with an axial recess in the cylinder housing;
a second fluid line in fluid communication with the center bore in a cylinder housing region, wherein the first and second fluid lines each is fluidly connected to a fluid reservoir at their respective other ends;
a third fluid line that interconnects the first and second fluid lines in a fluid manner;
a first valve that is at least one of electrically operable, hydraulically operable, and mechanically operable, wherein the first valve is situated in the third fluid line; and
a second valve that is at least one of electrically operable, hydraulically operable, and mechanically operable, wherein the second valve is situated in the second fluid line, in back of a fluid connection of the third fluid line to the second fluid line, when viewed in the direction of the fluid reservoir, wherein a build-up of fluid pressure is generated autonomously with the aid of the first valve, when the second valve interrupts a fluid stream in the second fluid line.

2. The brake booster as recited in claim 1, wherein in a region of the axial recess, the piston push rod has a first radial, conical expansion, which is fixed in position on the piston push rod and corresponds to a shape of the axial recess, the brake booster further comprising:
a first spring element by which the piston push rod is prestressed, wherein:
the first spring element being is situated inside the axial recess,
the first spring element is supported, on one side, at an inner wall of the axial recess, around a through-hole,
the first spring element is supported, on another side, at a plane surface of the first conical expansion, opposite to a conical surface, so that in a non-actuated state of the piston push rod, the conical surface of the first conical expansion forms, together with a correspondingly formed recess or surface, a seal for a fluid situated in the cylinder housing.

3. The brake booster as recited in claim 1, wherein:
in an actuated state of the piston push rod effected by the user corresponding to when the piston push rod is displaced in such a manner that the first conical expansion separates from a corresponding surface of the axial recess in opposition to a prestress force of the first spring element, a second radial expansion, which is fixed in position on the piston push rod, is provided with a conical surface, and is set apart from the first expansion, abuts on a correspondingly formed surface in the cylinder housing in a sealing manner, and in this way, the second fluid line is closed, and the fluid pressure is increased by a displacement of the first conical expansion inside of the axial recess.

4. The brake booster as recited in claim 3, further comprising:
a second spring element situated between a second expansion and a stop element that is set apart from the second conical expansion and is fixed in position on the piston push rod, wherein:
the second spring element is supported, on one side, at the stop element, and on the other side, at a plane surface of the second conical expansion, opposite to the conical surface, in order that in response to a displacement corresponding to an actuation of the piston push rod, a relatively effective seal is produced between the conical surface of the second conical expansion and a corresponding surface in the cylinder housing, due to a prestress force of the second spring element, and in order that a user is provided an option of selectively apportioning a measure of sealing or pressure build-up in the axial recess.

5. The brake booster as recited in claim 1, further comprising:
a fourth fluid line, wherein inside of the cylinder housing the third fluid line branches off from the first fluid line and opens out into the conical surface, so that upon actuation of the push-rod piston, a pressure equilibrium between a region in front of and in back of the first conical expansion may be generated.

6. The brake booster as recited in claim 1, wherein in place of the first and second conical expansions, in each instance, radial seals are fixed in position on the piston push rod; and at least two radial seals are set apart from one another in such a manner, that in the non-actuated state of the piston push rod, the second fluid line is in fluid communication with the center bore of the cylinder housing, and in the non-actuated state of the piston push rod, a further radial seal seals the axial recess and the center bore from one another.

7. The brake booster as recited in claim 6, wherein in an actuated state of the piston push rod effected by a user corresponding to when the piston push rod is displaced in a direction of the axial recess, on one hand, the seal between the axial recess and the center bore for building up fluid pressure is broken, and the two radial seals set apart from one another are displaced by the piston push rod in such a manner, that a fluid connection of the second fluid line to the center bore is interrupted.

8. The brake booster as recited in claim 4, wherein the second spring element is supported, on one side, at the stop element, and on the other side, at the cylinder housing, in order to provide a user an option to selectively apportion a measure of sealing or pressure build-up in the axial recess.

9. The brake booster as recited in claim 1, wherein the build-up of fluid pressure via the first valve may be generated by the fluid reservoir, the fluid reservoir including at least one of an accumulator and an ABS pump in conjunction with a check valve.

10. The brake booster as recited in claim 1, further comprising:
a fourth fluid line situated in the cylinder housing, the fourth fluid line opening out, on one end, into the center bore, and on the other end, to an exterior of the cylinder housing, in order to generate a pressure equalization for the center bore.

11. A vehicle, comprising:
a brake booster for a vehicle, comprising:
a cylinder housing including a center bore for receiving a user-operated push-rod piston for building up a fluid pressure inside the cylinder housing in response to actuation of the push-rod piston;
a first fluid line in fluid communication with an axial recess in the cylinder housing;
a second fluid line in fluid communication with the center bore in a cylinder housing region, wherein the first and second fluid lines each is fluidly connected to a fluid reservoir at their respective other ends;
a third fluid line that interconnects the first and second fluid lines in a fluid manner;
a first valve that is at least one of electrically operable, hydraulically operable, and mechanically operable, wherein the first valve is situated in the third fluid line; and
a second valve that is at least one of electrically operable, hydraulically operable, and mechanically operable, wherein the second valve is situated in the second fluid line, in back of a fluid connection of the third fluid line to the second fluid line, when viewed in the direction of the fluid reservoir, wherein a build-up of fluid pressure is generated autonomously with the aid of the first valve, when the second valve interrupts a fluid stream in the second fluid line.

12. The vehicle as recited in claim 11, wherein the vehicle is a motor vehicle.
